(19) United States
(12) Patent Application Publication
(10) Pub. No.: US 2023/0072204 A1
(43) Pub. Date: Mar. 9, 2023

(54) MOTORIZED WHEEL SYSTEM

(71) Applicant: Juliana T. IACONO, Elmhurst, IL (US)

(72) Inventor: Juliana T. IACONO, Elmhurst, IL (US)

(21) Appl. No.: 17/940,775

(22) Filed: Sep. 8, 2022

Related U.S. Application Data
(60) Provisional application No. 63/242,178, filed on Sep. 9, 2021.

(51) Int. Cl. B60K 7/00

(52) U.S. Cl. CPC B60K 7/0007; B62B 5/005

(57) ABSTRACT

The present disclosure relates to a motorized wheel system comprising a shaft comprising a proximal end and a distal end connected by an elongated middle portion, the proximal end of the shaft connected to a collar fastener, wherein the distal end of the shaft is attached to a connector; the collar fastener configured to attach to a transportable device; a connector connecting the distal end of the shaft to an outer retention enclosure; the outer retention enclosure comprising the outer surface, an inner surface, and a substantially hollow interior at least partially disposed around a motor unit and a wheel structure; the wheel structure comprising a wheel and a stabilizing unit connecting the wheel structure to the outer retention enclosure; and the motor unit configured to provide rotational movement to the wheel structure.

### CROSS-REFERENCE TO RELATED APPLICATIONS

This application claims the benefit of, and priority to, U.S. Provisional Patent Application No. 63/242,178, filed Sep. 9, 2021, which is incorporated by reference herein in its entirety for all purposes.

### BACKGROUND

Many daily use transportable devices have both non-motorized and motorized implementations. For example, transportable devices such as wheelchairs may be non-motorized, thus requiring human effort to move the wheelchair along a surface. Wheelchairs may also be motorized, but as can be appreciated, motorizing wheelchairs as is done in the prior art can be quite complex and can be quite expensive for the consumer. Another example of a transportable device is a pull-cart for golf. Pull-carts are non-motorized devices that a golfer may pull (or push) around the golf course. The motorized counterpart to a pull cart is a motorized golf cart. As can be appreciated, motorized golf carts are much more expensive and bulky relative to pull carts. Many motorized devices are typically bulky structures requiring a large motor and associated gearing, transmission, and power source relative to non-motorized counterparts. What is needed is a device for transforming non-motorized devices to motorized devices in a quick, efficient and inexpensive manner.

### BRIEF SUMMARY

According to one aspect of the subject matter described in this disclosure, a motorized wheel system is provided. The motorized wheel system includes a shaft and a wheel structure. A fastening device is coupled at one end of the shaft. Also, the fastening device is coupled to a transportable device. An motor unit is coupled to another end of the shaft. The motor unit is configured to provide power to the wheel structure to move or assist with movement of the transportable device.

According to one aspect of the subject matter described in this disclosure, a motorized wheel system may be provided. The motorized wheel system may include a shaft having a proximal end and a distal end that are connected by an elongated middle portion. The proximal end of the shaft may be connected to a collar fastener, and the distal end of the shaft may be connected to a connector. The collar fastener may be configured to attach to a transportable device. The connector connects the distal end of the shaft to an outer retention enclosure and provides a limited rotation angle between the distal end of the shaft and an outer surface of the outer retention enclosure. The outer retention enclosure includes an outer surface, an inner surface, and a substantially hollow interior at least partially disposed around a motor unit and a wheel structure. The motor unit may include a motor and a motor mount connecting the motor to the outer retention enclosure. The motor unit may be configured to provide rotational movement to the wheel structure. The wheel structure includes a wheel and a stabilizing unit connecting the wheel to the outer retention enclosure.

In some embodiments, a motorized wheel system may include a power control mechanism configured to adjust power provided from the motor to the wheel structure, thereby adjusting a speed of a rotational movement of a wheel structure. The motorized wheel system may further contain an independent energy storage system having at least one of a battery and a solar cell. A cross section of a shaft may have a shape selected from the group consisting of a triangle, a circle, a square, a pentagon, a hexagon, an oval, a rhombus, a heptagon, and an octagon. A collar fastener may be configured to attach to at least one of a bar, shaft, and rod of the transportable device. In some embodiments, the collar fastener may be detachable from the transportable device. A connector may be adjustable to maintain engagement between the wheel system and a floor surface. A solar cell may be attached to the enclosed motor unit. An enclosure may be made from weather resistant material, such as metal, or the connector may be made from at least one of a metal and a plastic, or the shaft may be made from at least one of a metal and a plastic including a high-grade plastic. The wheel structure may further include a stabilizing unit made from one of a metal and a plastic including a high-grade plastic.

In some embodiments, a wheel structure may further include a plurality of wheels, and where each wheel of the wheel structure may be modular. Each wheel may be made from an alloy of iron and carbon, a metal, or a rubber including a high-grade rubber. The motorized wheel system may further contain a power control mechanism including one of a handle, a button, a lever, a switch, and a dial. The power control mechanism may be attached to the transportable device. The motorized wheel system may contain a sensor, wherein the sensor may be capable of automatically adjusting the power the motor unit provides to the wheel structure based on the terrain. The motorized wheel system may include a sensor connected to the motor and the wheel structure and configured to automatically adjust the rotational speed of the wheel structure based on the weight of the transportable device. The motorized wheel system may contain a second linkage system including a second collar fastener, a second shaft, and a second connector. The collar fastener contains a first portion and a second portion, wherein the first portion and second portion partially enclose a grip portion and the first portion and second portion tighten to adhere the collar fastener to a transportable device. The collar fastener may include an adhesive on an interior surface of the collar fastener configured to adhere the collar fastener to the transportable device. The transportable device may include a wheel chair, a push cart, a golf pull cart, a stroller, or a grocery cart.

In some embodiments, the present disclosure relates to a motorized wheel system including a shaft having a proximal end and a distal end that are connected by an elongated middle portion having a circular cross section. The proximal end of the shaft may be connected to a collar fastener. The distal end of the shaft may be attached to a connector. The motorized wheel system may include the collar fastener configured to attach to at least one of a bar, shaft, and rod of a transportable device. The collar fastener may be detachable from the transportable device. The collar fastener may contain a first portion and a second portion that partially enclose a grip portion and tighten to adhere the collar fastener to the transportable device. The motorized wheel system may include a connector connecting the distal end of the shaft to an outer retention enclosure, wherein the connector may provide a limited rotation angle between the distal end of the shaft and an outer surface of the outer retention enclosure. The motorized wheel system may include the outer retention enclosure having the outer surface, an inner surface, and a substantially hollow interior at least partially disposed around a motor unit and a wheel structure. The motorized wheel system may include the wheel structure including a wheel and a stabilizing unit connecting the wheel to the outer retention enclosure. The motor unit may include a motor and a motor mount connecting the motor to the outer retention enclosure, the motor unit configured to provide rotational movement to the wheel structure. The motorized wheel system may include an independent energy storage system including at least one of a battery and a power control mechanism configured to adjust power provided from the motor to the wheel structure, thereby adjusting the speed of the rotational movement of the wheel structure, wherein the power control mechanism may be attached to the transportable device.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1 is a schematic diagram illustrating a bottom perspective view of a motorized wheel system, in accordance with some embodiments.

FIG. 2 is a schematic diagram illustrating a detailed side perspective view of the motorized wheel system of FIG. 1, in accordance with some embodiments.

FIG. 3 is a schematic diagram illustrating a top perspective view of the motorized wheel system of FIG. 1, in accordance with some embodiments.

FIG. 4A is a schematic diagram illustrating a detailed side perspective view of the motorized wheel system of FIG. 1, in accordance with some embodiments.

FIG. 4B is a schematic diagram illustrating a side perspective of the motorized wheel system of FIG. 1, attached to a transportable device, in accordance with some embodiments.

FIG. 4C is a schematic diagram illustrating the power control mechanism of the motorized wheel system of FIG. 1, attached to a transportable device, in accordance with some embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

The disclosure includes a motorized wheel system that can be connected to one or more transportable devices. The motorized wheel system may assist moving the one or more transportable devices without requiring additional power from the transportable device. In some embodiments, the motorized wheel system provides a movement force that can be combined with force provided by a user and or attendant of the user of the device. Moreover, the motorized wheel system is easily portable. In addition, the motorized wheel system can work in conjunction with the transportable device without requiring complicated devices or machinery. Indeed, the motorized wheel system may be modular, and thus easy to attach/detach to the transportable devices or systems as operations may require.

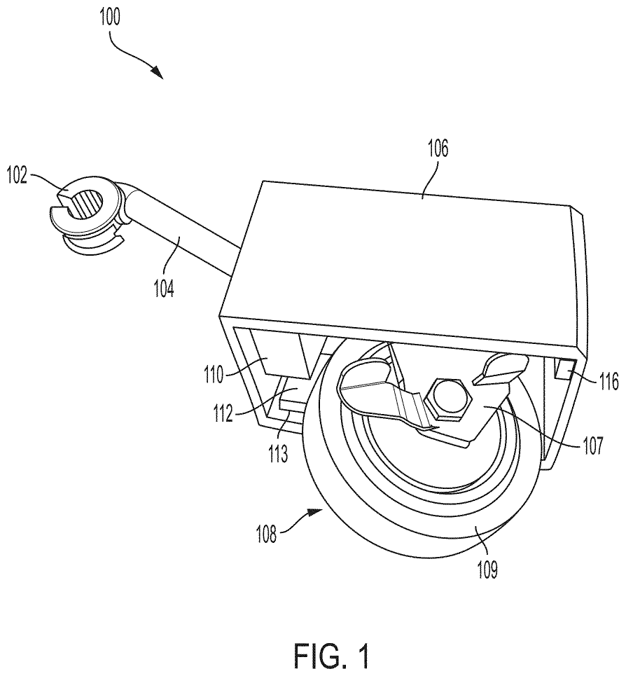

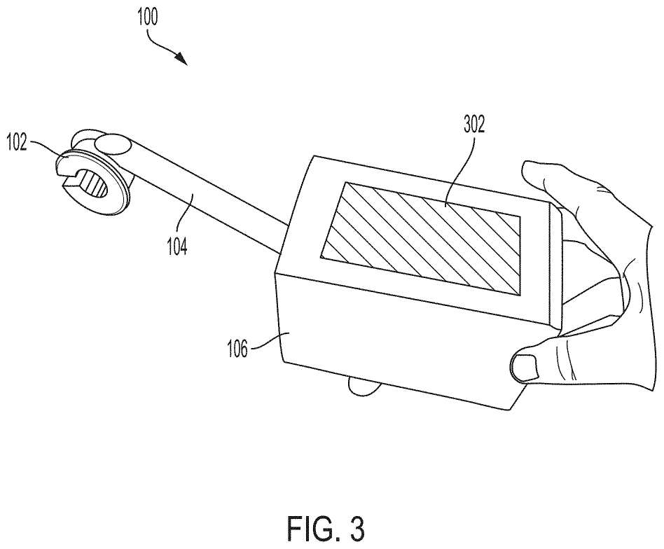

FIG. 1 is a schematic diagram illustrating a bottom perspective view of a motorized wheel system 100, in accordance with some embodiments. The motorized wheel system 100 may include a fastening device 102 (e.g., collar fastener), a shaft 104, and an outer retention enclosure 106, a stabilizing unit 107, a wheel structure 108, a wheel 109, a battery 110, a motor unit 112, a motor mount 113, and a sensor 116. The fastening device 102, such as a collar fastener, may be used to connect a transportable device 406 needing assistance with movement. In some embodiments, the motorized wheel system 106 may include a plurality of shafts 104, and fastening devices 102 (e.g., collar fastener). The transportable device 406 may include a wheel chair, a push cart, a golf pull cart, a stroller, a grocery cart, and the like. A shaft 104 may include a proximal end and a distal end that are connected by an elongated middle portion. The elongated middle portion of the shaft has a shape selected from the group consisting of a triangle, a circle, a square, a pentagon, a hexagon, an oval, a rhombus, a heptagon, and an octagon. One end of shaft 104 may be connected to the fastening device 102 (e.g., collar fastener), and another end of shaft 104 is connected to the outer retention enclosure 106 via connector 206, to be further discussed in FIG. 3. Connector 206 may include a hinge, including a ball bearing hinge, a spring-loaded hinge, a barrel hinge, a concealed hinge, an overlay hinge, an offset hinge, a piano hinge, a strap hinge, and the like. A connector 206 may include various fasteners, including screws, rivets, clamps, retaining rings, welds, studs, and the like. Connector 206 may provide a limited rotation angle between a distal end of the shaft and an outer surface of the outer retention enclosure 106. The transportable device 406 may include a variety of daily or non-daily use structures, such as wheelchairs, push carts, pull golf carts, strollers, grocery carts, or any other non-motorized device or system that would benefit from a modular, easy to use, motive source to provide motorized movement assistance either alone or in conjunction with a human-provided movement force.

In some embodiments, multiple motorized wheel systems 100 may be used in tandem to move the transportable device 406. The multiple motorized wheel systems 100 may use one or more power control mechanisms 404 or one or more connection mechanisms 405.

The outer retention enclosure 106 may include an outer surface, an inner surface, and a substantially hollow interior that protects a motor unit 112 stored within. For example, the outer retention enclosure 106 may be at least partially disposed around a motor unit 112 and a wheel structure 108. The enclosure may protect the motor unit 112 from damage from outside elements. Moreover, the outer retention enclosure 106 may be connected to a wheel structure 108 and configured to provide the necessary power to move a single wheel structure 108 when fastening device 102 (e.g., collar fastener) is connected to a transportable device. In some embodiments, the motor unit 112 powers the wheel structure 108 through conventional arrangements, such as a direct drive, pulley, belts, sprockets, chains, gears, springs, and the like. The fastening device 102 (e.g., collar fastener) may attach to one or more of a bar, a shaft, and a rod of the transportable device 406. The fastening device 102 (e.g., collar fastener) may include a series of grips, ridges, adhesives, or any other interior surface modifications to assist with connecting to transportable device. Wheel structure 108 may include one or more stabilizing units 107 designed to maintain the stability of a wheel 109 while in motion. The stabilizing unit 107 may connect the wheel 109 to the outer retention enclosure 106. Shaft 104 may be of sufficient strength to withstand the forces associated with moving a transportable device 406 while being connected to fastening device 102 (e.g., collar fastener) and outer retention enclosure 106. For example, the shaft 104 may be formed of a metal, such as reinforced steel. In other embodiments, the shaft 104 may be formed of high-grade plastics.

In some embodiments, the motor unit 112 may be attached to the outer retention enclosure 106 through a motor mount 113. A motor mount 113 may include any mounting system known, including an adhesive, a weld, a polymer mount (e.g., rubber, polyurethane, polypropylene, polyethylene, etc.), a metal mount, and a combination thereof. The motor unit 112 may include a battery 110 that can be attached to the motor unit 112 and/or the outer retention enclosure 106 through any known mounting system. In some embodiments, the motor unit 112 may include a battery-powered motor, an electric motor, and a hybrid thereof. Such battery-powered motor may be rechargeable. Motor unit 112 may be powered directly from solar cell 302 (See FIG. 3). Additionally, battery 110 may be charged and/or recharged by solar cell 302. In other embodiments, the solar cell 302 or cells may be provided on an exterior top surface of the outer retention enclosure 106 to enable power generation when used outdoors. In such embodiments, the solar cell 302 (e.g., solar panel) or cells are rechargeable. The solar cell may serve as an independent energy storage system for each of the battery 110, the motor unit 112, the sensor 116, and the power control mechanism 404 (see FIG. 3). In some embodiments, the solar cell 302 or cells may be attached to the transportable device 406.

In some embodiments, an outer retention enclosure 106 may be formed of a metal structure. In some embodiments, the outer retention enclosure 106 may be formed with weather resistant materials. A connector 206 may be made from a plastic, a metal, or a combination thereof. A shaft 104 may be made from at least one of a metal and a plastic, such as a high-grade plastic.

In some embodiments, the wheel structure 108 may include a wheel 109 made from an alloy of iron and carbon. In some embodiments, the wheel structure 108 may include a wheel 109 made from high-grade rubber. In some embodiments, the wheel structure 108 may include stabilizing units 107 made from metal. In some implementations, the wheel structure 108 may include stabilizing units 107 made from high-grade plastics. The wheel structure 108 may include one or more wheels 109. For example, the wheel structure 108 may include two or three wheels 109 depending on the desired stability and size of the wheel structure 108 or motorized wheel system 100. The wheels 109 may be modular, such that wheels can be easily swapped in and out of the device. Also, it is contemplated that the device can be modified in the number of wheels 109 used. For example, the device can be modified to have one wheel 109 for one use, two wheels 109 for a second use, three wheels 109 for a third use, and so on.

In addition, the outer retention enclosure 106 may assist one or more transportable devices or systems to move across difficult terrain. In particular, the outer retention enclosure 106 may adjust the amount of power it provides wheel structure 108 depending on the terrain and weight of the one or more transportable devices.

In some embodiments, the outer retention enclosure 106 may include a sensor 116 to assess the terrain. In some embodiments, the outer retention enclosure 106 may include a controller to adjust the power provided to the wheel structure 108 based on signals from the sensor 116. The sensor 116 may be capable of automatically adjusting the power the motor unit 112 provides to the wheel structure based on the terrain. The sensor 116 may be connected to the motor unit 112 and the wheel structure 108 and may be configured to automatically adjust the rotational speed of the wheel structure 108 based on the weight of a transportable device.

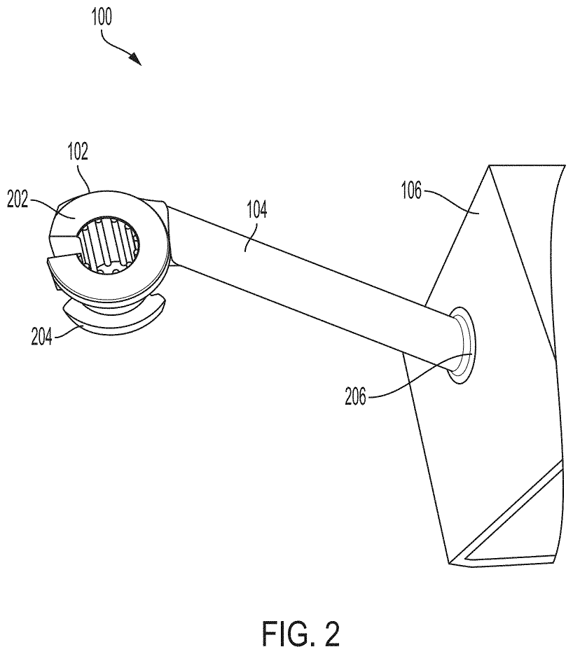

FIG. 2 is a schematic diagram illustrating a detailed side perspective view of the motorized wheel system of FIG. 1, in accordance with some embodiments. Also, FIG. 2 shows a fastening device 102 (e.g., collar fastener) having a first portion 202 and a second portion 204. First portion 202 and second portion 204 may be movable parts that may adjust the fastening of the motorized wheel system 100 to a surface of a transportable device. In some embodiments, first portion 202 and second portion 204 may be attached to each other to form a fastening device 102 (e.g., collar fastener). It is to be appreciated that the fastening device 102 (e.g., collar fastener) may be contracted or expanded to accommodate attachment to structure of different sizes. The fastening device 102 (e.g., collar fastener) may also be modified in terms of its shape in order to accommodate attachment to structures of different shapes, such as those having a round or square profile. Moreover, FIG. 2 shows a connector 206 that may connect shaft 104 with outer retention enclosure 106 allowing only a limited rotation angle (e.g., less than 90 degrees, and more preferably less than 60 degrees) between them. A limited rotation angle may include less than about 90 degrees, less than about 80 degrees, less than about 70 degrees, less than about 60 degrees, less than about 50 degrees, less than about 40 degrees, less than about 30 degrees, less than about 20 degrees, less than about 10 degrees, and less than about 5 degrees, where about includes plus or minus 5 degrees. Furthermore, shaft 104 and outer retention enclosure 106 may substantially rotate relative to each other about a fixed axis of rotation.

In other embodiments, the fastening device 102 (e.g., collar fastener) may include any fastening device or adhesive structure that can attach a transportable device to shaft 104.

In some embodiments, the connector 206 may be formed of the same materials as shaft 104. In some embodiments, the connector 206 may be made from a metal structure. In some embodiments, the connector 206 may be made from one or more plastic materials.

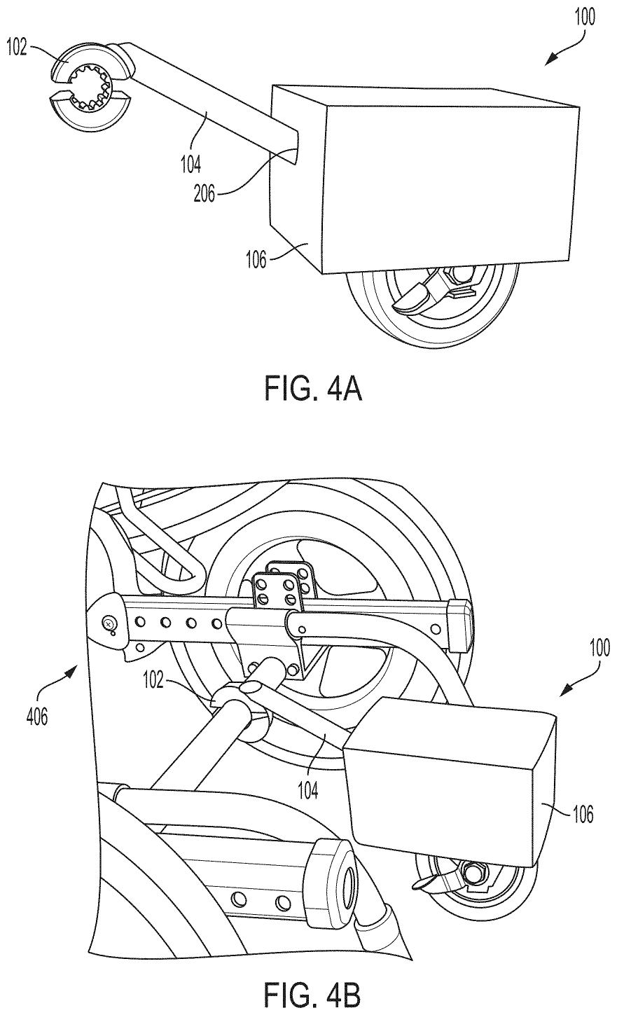

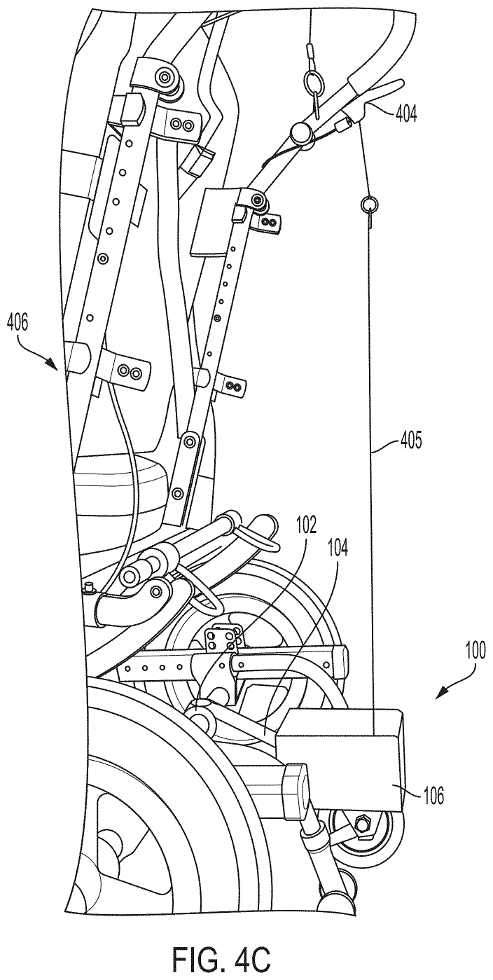

FIG. 3 is a schematic diagram illustrating a top perspective view of the motorized wheel system 100 of FIG. 1, in accordance with some embodiments. In particular, FIG. 3 shows the stability of the motorized wheel system 100 when held upright. In some embodiments, as is shown in FIG. 3, an outer retention enclosure 106 may include a solar cell 302. The solar cell 302 may provide energy to recharge battery 110. The solar cell 302 may provide energy to motor unit 112, sensor 116, and power control mechanism 404 (See FIG. 4C).

Additional view of the motorized wheel system according to the present disclosure are shown in FIGS. 4A-4C. In some embodiments, the motorized wheel system may include more than one linkage system to facilitate coupling of the motorized wheel unit to the transportable device. The linkage system may include a shaft, a connector, and a fastening device (e.g., collar fastener). For example, the motorized wheel system may include two, three, four, or even more linkage systems. Various other coupling mechanisms are contemplated herein. Further, as shown in FIG. 4C, a connection mechanism 405, such as string, cable, wire or the like, may couple the handle bar of the transportable device to the motorized wheel system 100. A motorized wheel system 100 may include a power control mechanism 404 including one or more of a handle, a button, a lever, a switch, a dial, or the like. The power control mechanism 404 may be attached to the transportable device 406. Such arrangement may facilitate controlling the speed of the motorized wheel unit by squeezing the handle bar to throttle the motor of the motorized wheel unit to thereby enact motion.

This disclosure describes a novel motorized wheel system that can be connected to one or more transportable devices. The motorized wheel system may help move the one or more transportable devices without requiring additional power from the transportable devices. The motorized wheel system may be used with or without additional human-applied force. Moreover, the motorized wheel system can work in conjunction with transportable devices or systems to assist in moving these structures without requiring complicated devices or machinery. For example, the motorized wheel system may assist moving wheelchairs, pushcarts, golf pull carts, strollers, grocery carts or the like across relatively flat or undulating surfaces or terrains by providing additional power and stability to the one or more transportable devices or systems. This may help with movement of persons having mobility difficulties requiring a transport system, such as a wheelchair or the like, to move across difficult terrain such as up a hill.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A motorized wheel system comprising:
(a) a shaft comprising a proximal end and a distal end that are connected by an elongated middle portion, wherein the proximal end of the shaft is connected to a collar fastener, and wherein the distal end of the shaft is attached to a connector;
(b) the collar fastener configured to attach to a transportable device;
(c) the connecter connecting the distal end of the shaft to an outer retention enclosure, wherein the connector provides a limited rotation angle between the distal end of the shaft and an outer surface of the outer retention enclosure;
(d) the outer retention enclosure comprising the outer surface, an inner surface, and a substantially hollow interior at least partially disposed around a motor unit and a wheel structure;
(e) the wheel structure comprising a wheel and a stabilizing unit connecting the wheel to the outer retention enclosure; and
(f) the motor unit comprising a motor and a motor mount connecting the motor to the outer retention enclosure, the motor unit configured to provide rotational movement to the wheel structure.

2. The motorized wheel system of claim 1, further comprising a power control mechanism configured to adjust power provided from the motor to the wheel structure, thereby adjusting the speed of the rotational movement of the wheel structure.

3. The motorized wheel system of claim 1, further comprising an independent energy storage system comprising at least one of a battery and a solar cell.

4. The motorized wheel system of claim 1, wherein a cross section of the elongated middle portion of the shaft has a shape selected from the group consisting of a triangle, a circle, a square, a pentagon, a hexagon, an oval, a rhombus, a heptagon, and an octagon.

5. The motorized wheel system of claim 1, wherein the collar fastener is configured to attach to at least one of a bar, shaft, and rod of the transportable device.

6. The motorized wheel system of claim 1, wherein the collar fastener is detachable from the transportable device.

7. The motorized wheel system of claim 1, wherein the connector is adjustable to maintain engagement between the wheel system and a floor surface.

8. The method of claim 1, further comprising a solar cell, wherein the solar cell is attached to one of the enclosed motor unit and the transportable device.

9. The motorized wheel system of claim 1, wherein at least one of:
the enclosure is made from weather resistant material, such as metal,
the connector is made from at least one of a metal and a plastic, and
the shaft is made from at least one of a metal and a plastic comprising a high-grade plastic.

10. The motorized wheel system of claim 1, wherein the wheel structure further comprises a stabilizing unit made from one of a metal and a plastic comprising a high-grade plastic.

11. The motorized wheel system of claim 1, wherein the wheel structure further comprises a plurality of wheels, and where each wheel of the wheel structure is modular.

12. The motorized wheel system of claim 13, wherein each wheel is made from at least one of an alloy of iron and carbon, a metal, and a rubber comprising a high-grade rubber.

13. The motorized wheel system of claim 2, wherein the power control mechanism comprises one of a handle, a button, a lever, a switch, and a dial, wherein the power control mechanism is attached to the transportable device.

14. The motorized wheel system of claim 1, further comprising a sensor, wherein the sensor is capable of automatically adjusting the power the motor unit provides to the wheel structure based on the terrain.

15. The motorized wheel system of claim 1, further comprising a sensor connected to the motor unit and the wheel structure and configured to automatically adjust the rotational speed of the wheel structure based on the weight of the transportable device.

16. The motorized wheel system of claim 1, further comprising a second linkage system comprising a second collar fastener, a second shaft, and a second connector.

17. The motorized wheel system of claim 1, wherein the collar fastener contains a first portion and a second portion, wherein the first portion and the second portion partially enclose a grip portion and the first portion and the second portion tighten to adhere the collar fastener to the transportable device.

18. The motorized wheel system of claim 1, wherein the collar fastener comprises an adhesive on an interior surface of the collar fastener configured to adhere the collar fastener to the transportable device.

19. The motorized wheel system of claim 1, wherein the transportable device comprises a wheel chair, a push cart, a golf pull cart, a stroller, or a grocery cart.

20. A motorized wheel system comprising:
(a) a shaft comprising a proximal end and a distal end that are connected by an elongated middle portion having a circular cross section, wherein the proximal end of the shaft is connected to a collar fastener, and wherein the distal end of the shaft is attached to a connector;
(b) the collar fastener configured to attach to at least one of a bar, shaft, and rod of a transportable device, wherein the collar fastener is detachable from the transportable device, and wherein the collar fastener contains a first portion and a second portion that partially enclose a grip portion and tighten to adhere the collar fastener to the transportable device;
(c) the connector connecting the distal end of the shaft to an outer retention enclosure, wherein the connector provides a limited rotation angle between the distal end of the shaft and an outer surface of the outer retention enclosure;
(d) the outer retention enclosure comprising the outer surface, an inner surface, and a substantially hollow interior at least partially disposed around a motor unit and a wheel structure;
(e) the wheel structure comprising a wheel and a stabilizing unit connecting the wheel to the outer retention enclosure;
(f) the motor unit comprising a motor and a motor mount connecting the motor to the outer retention enclosure, the motor unit configured to provide rotational movement to the wheel structure;
(g) an independent energy storage system comprising at least one of a battery and a solar cell; and
(h) a power control mechanism configured to adjust power provided from the motor to the wheel structure, thereby adjusting the speed of the rotational movement of the wheel structure, wherein the power control mechanism is attached to the transportable device.
